(19) United States
(12) Patent Application Publication
(10) Pub. No.: US 2013/0019651 A1
(43) Pub. Date: Jan. 24, 2013

(54) ABNORMALITY DETECTION APPARATUS FOR FUEL PROPERTY DETECTION APPARATUS

(71) Applicants: Takanori Sasaki, Susono-shi (JP); Kazuhiro Wakao, Susono-shi (JP); Mie Sasai, Susono-shi (JP)

(72) Inventors: Takanori Sasaki, Susono-shi (JP); Kazuhiro Wakao, Susono-shi (JP); Mie Sasai, Susono-shi (JP)

(73) Assignee: TOYOTA JIDOSHA KABUSHIKI KAISHA, Toyota-shi, Aichi-ken (JP)

(21) Appl. No.: 13/635,791

(22) PCT Filed: Apr. 15, 2010
(86) PCT No.: PCT/JP2010/056788

§ 371 Date: Sep. 18, 2012

(51) Int. Cl. G01N 27/24

(52) U.S. Cl. 73/1.02

(57) ABSTRACT

An object of the present invention is to accurately diagnose an abnormality of a fuel property detection apparatus that detects a fuel property based on a capacitance between electrodes. The abnormality detection apparatus for a fuel property detection apparatus of the present invention detects an abnormality of a fuel property detection apparatus that detects a fuel property based on a measurement value of a capacitance between a pair of electrodes installed on a fuel supply channel of an internal combustion engine that can use a fuel that includes a predetermined fuel component that has a characteristic such that a permittivity thereof changes according to a frequency of an electric field. The abnormality detection apparatus for a fuel property detection apparatus includes frequency switching means that switches a frequency of an alternating voltage applied between both electrodes to a plurality of frequencies, measuring means that measures a capacitance at each of the plurality of frequencies, storing means that stores frequency characteristics information that is information relating to a relationship between a fuel property and frequency characteristics of capacitances when the fuel property detection apparatus is normal, and diagnosing means that diagnoses an abnormality of the fuel property detection apparatus based on a measurement result of the measuring means and the frequency characteristics information.

### TECHNICAL FIELD

The present invention relates to an abnormality detection apparatus for a fuel property detection apparatus.

### BACKGROUND ART

A blended fuel made by blending a fuel produced from biomass (for example, ethanol) and a conventional fuel (for example, gasoline) is being used for internal combustion engines of automobiles and the like. Fuel characteristics such as a stoichiometric air/fuel ratio and a heat release value differ between gasoline and ethanol. Hence, the characteristics of an ethanol-gasoline blended fuel change according to an ethanol concentration thereof. Consequently, an apparatus that detects an ethanol concentration of a fuel is necessary in order to appropriately control an internal combustion engine that uses an ethanol-gasoline blended fuel. A capacitance-type fuel property detection apparatus is known as an apparatus that can detect an ethanol concentration of a fuel. A capacitance-type fuel property detection apparatus has a pair of electrodes that are arranged on a fuel supply channel, and measures a capacitance between the electrodes. There is a significant difference between the permittivity of gasoline and the permittivity of ethanol. Consequently, the capacitance changes according to the ethanol concentration of a fuel that is present between the electrodes. Accordingly, the ethanol concentration can be detected by measuring the capacitance between the electrodes.

Regulations that make it mandatory to mount an on-board diagnostic system (OBD system) also require that the aforementioned kind of capacitance-type fuel property detection apparatus is checked to determine whether the apparatus is operating normally, and that an abnormality is accurately detected if an abnormality occurs.

As a method for diagnosing the existence of an abnormality in alcohol concentration detection means that detects an alcohol concentration of a fuel that is supplied to an internal combustion engine, Japanese Patent Laid-Open No. 2008-309047 discloses a method that makes a diagnosis in accordance with whether or not a variation (for example, a difference between a current value and a previous value) in alcohol concentration detection values is within a predetermined range.

### CITATION LIST

### Patent Literature

Patent Literature 1: Japanese Patent Laid-Open No. 2008-309047

Patent Literature 2: Japanese Patent Laid-Open No. 2009-145131

Patent Literature 3: Japanese Patent Laid-Open No. 4-101032

### SUMMARY OF INVENTION

### Technical Problem

In a capacitance-type fuel property detection apparatus, in some cases a gum component included in a fuel gradually accumulates between electrodes or rust develops on the electrodes, and consequently a change (error) arises in a measurement value of the capacitance. Since a fuel property can not be accurately detected in such a case, it is necessary for such a case to be detected as an abnormality.

However, according to a simple diagnostic method disclosed in the aforementioned Japanese Patent Laid-Open No. 2008-309047, it is not possible to detect a slow change such as the build-up of a gum component or the generation of rust as described above as an abnormality.

Further, Japanese Patent Laid-Open No. 4-101032 discloses a method that determines whether or not an alcohol concentration sensor is operating abnormally in accordance with whether or not an output voltage value of the alcohol concentration sensor is within an allowable range. According to this method, although an abnormality can be detected in a case where a detection value is an extreme value, such as a value when there is a disconnection in a sensor portion, it is difficult to detect a small change such as accumulation of a gum component or the occurrence of rust as an abnormality.

Furthermore, although a method may be considered in which another pair of reference electrodes are provided for the purpose of diagnosing a fault, there is the problem that in such a case the sensor structure will be complicated and increase in size, and costs will also increase. Further, since an abnormality such as the build-up of a gum component or the occurrence of rust may also occur at the reference electrodes, there is the problem that an accurate fault diagnosis can not necessarily be made even if a comparison is made with the reference electrodes.

The present invention has been made in consideration of the above circumstances, and an object of the invention is to provide an apparatus that can accurately diagnose an abnormality of a fuel property detection apparatus that detects a fuel property based on a capacitance between electrodes.

### Solution to Problem

A first invention for achieving the above object is an abnormality detection apparatus for a fuel property detection apparatus that detects an abnormality of a fuel property detection apparatus that detects a fuel property based on a measurement value of a capacitance between a pair of electrodes that are installed on a fuel supply channel of an internal combustion engine that is capable of using a fuel including a predetermined fuel component that has a characteristic such that a permittivity thereof changes in accordance with a frequency of an electric field, comprising:

frequency switching means that switches a frequency of an alternating voltage that is applied between the two electrodes to a plurality of frequencies at which respective values of a permittivity of the predetermined fuel component are different;

measuring means that measures the capacitance at each of the plurality of frequencies;

storing means that stores frequency characteristics information that is information relating to a relationship between a fuel property and a frequency characteristic of the capacitance in a case where the fuel property detection apparatus is normal; and

diagnosing means that diagnoses an abnormality of the fuel property detection apparatus based on a result of a measurement by the measuring means and the frequency characteristics information.

A second invention is in accordance with the first invention, wherein:

the frequency switching means switches a frequency of an alternating voltage that is applied between the two electrodes between a first frequency and a second frequency at which a permittivity of the predetermined fuel component becomes a value that is different from a value thereof at the first frequency;

the measuring means measures a first capacitance that is a capacitance between the two electrodes when an alternating voltage at the first frequency is applied, and a second capacitance that is a capacitance between the two electrodes when an alternating voltage at the second frequency is applied;

the frequency characteristics information is information relating to a relationship between a fuel property and a ratio between the first capacitance and the second capacitance in a case where the fuel property detection apparatus is normal; and

the diagnosing means includes:

normal ratio acquiring means that acquires normal ratio information that is information relating to a normal ratio between the first capacitance and the second capacitance, based on a fuel property that is detected by the fuel property detection apparatus and the frequency characteristics information, and

abnormality determining means that determines an existence or non-existence of an abnormality of the fuel property detection apparatus based on a measurement value of the first capacitance, a measurement value of the second capacitance, and the acquired normal ratio information.

A third invention is in accordance with the first or the second invention, wherein:

the normal ratio acquiring means acquires an upper limit value and a lower limit value of a normal ratio between the first capacitance and the second capacitance; and

the abnormality determining means determines that there is an abnormality in the fuel property detection apparatus in a case where a ratio between a measurement value of the first capacitance and a measurement value of the second capacitance is not in a range from the upper limit value to the lower limit value.

A fourth invention is in accordance with the second or the third invention, wherein:

the first frequency is a frequency that the fuel property detection apparatus normally uses to detect a fuel property;

the second frequency is lower than the first frequency; and

a permittivity of the predetermined fuel component at the second frequency is higher than a permittivity of the predetermined fuel component at the first frequency.

A fifth invention is in accordance with any one of the first to the fourth inventions, wherein the frequency switching means switches the frequency to the plurality of frequencies before startup of the internal combustion engine or during execution of a fuel cut operation at the internal combustion engine, and the diagnosing means diagnoses an abnormality of the fuel property detection apparatus based on measurement values of capacitances at the respective frequencies that are measured at that time.

A sixth invention is in accordance with any one of the first to the fifth inventions, further comprising second diagnosing means that diagnoses an abnormality of the frequency switching means based on measurement values of capacitances at each of the plurality of frequencies.

A seventh invention is in accordance with the sixth invention, wherein the second diagnosing means determines that there is an abnormality in the frequency switching means when a difference between the measurement values of the capacitances at each of the plurality of frequencies is less than a predetermined criterion.

An eighth invention is in accordance with any one of the first to the seventh inventions, further comprising:

phase separation determining means that determines a possibility that a phase separation is occurring among a plurality of components constituting the fuel;

wherein an abnormality diagnosis with respect to the fuel property detection apparatus is not executed when the phase separation determining means determines that there is a possibility that the phase separation is occurring.

A ninth invention is in accordance with the eighth invention, wherein the phase separation determining means determines a possibility that the phase separation is occurring based on a concentration of the predetermined fuel component, a stoppage period of the internal combustion engine, and information relating to a water content in the fuel.

### Advantageous Effects of Invention

According to the first invention, a diagnosis can be conducted with respect a fuel property detection apparatus by comparing information relating to an inherent frequency characteristic of a capacitance that is in accordance with a fuel property, with a measurement value of a capacitance. Consequently, an accurate diagnosis can be made even when an abnormality exists in a case such as when the characteristics of a fuel property detection apparatus slowly change (for example, when there is a build-up of a gum component at an electrode or rust develops at an electrode).

According to the second invention, a precise diagnosis can be made using a relatively simple method.

According to the third invention, a precise diagnosis can be made using a relatively simple method.

According to the fourth invention, an abnormality diagnosis can be executed by switching from a first frequency that is normally used to a second frequency that is a lower frequency than the first frequency and for which a permittivity (capacitance) becomes higher than in the case of the first frequency. Thus, a diagnosis can be performed rapidly and easily.

According to the fifth invention, an abnormality diagnosis can be executed before starting an internal combustion engine or during execution of a fuel cut operation. It is thereby possible to ensure that a property and a temperature of a fuel that is between electrodes do not change during the diagnosis. Thus, an erroneous determination can be reliably prevented by a simple method.

According to the sixth invention, since it is possible to diagnose the existence of an abnormality in frequency switching means, an erroneous determination of an abnormality of the fuel property detection apparatus can be prevented with even greater reliability.

According to the seventh invention, an abnormality of the frequency switching means can be precisely diagnosed by a simple method.

According to the eighth invention, since an abnormality diagnosis of the fuel property detection apparatus is not executed when there is a possibility that a phase separation of the fuel is occurring, an erroneous determination can be reliably prevented.

According to the ninth invention, a possibility that a phase separation is occurring can be determined with a high degree of accuracy.

### BRIEF DESCRIPTION OF DRAWINGS

FIG. 1 is a view that schematically illustrates a configuration of an apparatus according to Embodiment 1 of the present invention.

FIG. 2 is a view that illustrates a relationship between an ethanol concentration and a temperature of a fuel and a capacitance.

FIG. 3 is a view that schematically illustrates electrodes.

FIG. 4 is a view that schematically illustrates a state in which one portion of a gap between the electrodes is blocked by a deposit of a gum component.

FIG. 5 is a view that compares a capacitance in a normal state in which there is no deposit in the gap between the electrodes and a capacitance in a state in which the deposit exists.

FIG. 6 is a view that illustrates a relationship between a permittivity and frequency.

FIG. 7 is a view that illustrates a relationship between the frequency of an electrode application voltage and the capacitance.

FIG. 8 is a view for describing an abnormality detection method according to Embodiment 1 of the present embodiment.

FIG. 9 is a view that illustrates an example of changes over time in the frequency of the electrode application voltage as well as detection values for the capacitance, fuel temperature and ethanol concentration. FIG. 10 is a flowchart illustrating a routine that is executed by Embodiment 1 of the present invention.

FIG. 11 is a flowchart illustrating a routine that is executed by Embodiment 2 of the present invention.

FIG. 12 is a flowchart illustrating a routine that is executed by Embodiment 3 of the present invention.

FIG. 13 is a flowchart illustrating a routine that is executed by Embodiment 4 of the present invention.

### DESCRIPTION OF EMBODIMENTS

Hereunder, embodiments of the present invention are described with reference to the drawings. In this connection, elements that are common to the respective drawings are denoted by the same reference symbols, and a duplicate description thereof is omitted.

### Embodiment 1

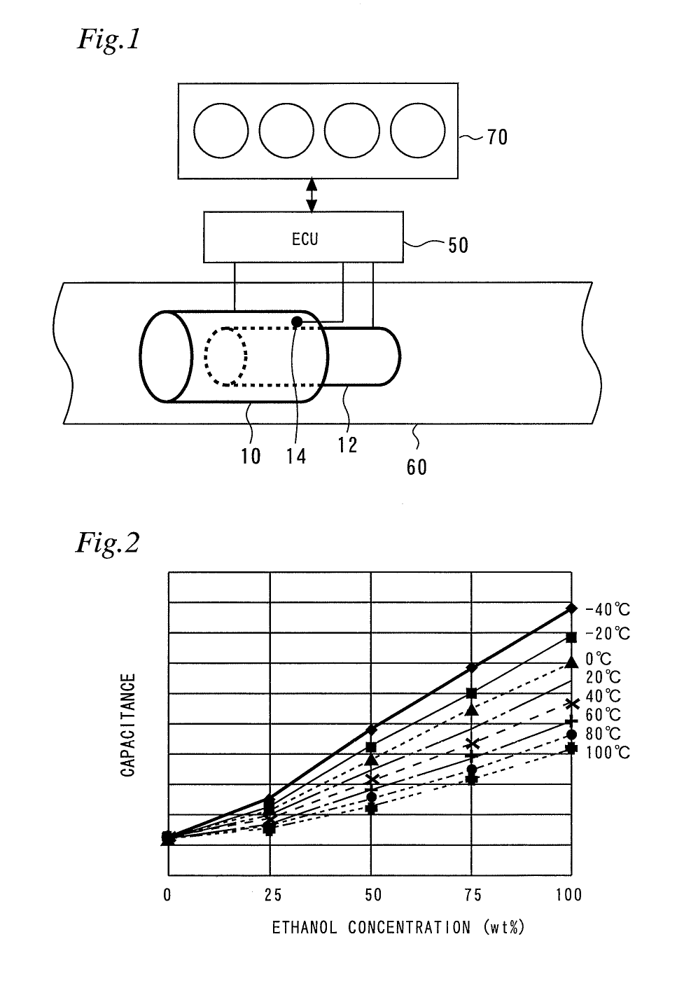

FIG. 1 is a view that schematically illustrates a configuration of an apparatus according to Embodiment 1 of the present invention. The apparatus of the present embodiment that is shown in FIG. 1 is mounted in an automobile in which a fuel (according to the present embodiment, an ethanol-gasoline blended fuel) that includes a fuel component (according to the present embodiment, ethanol) derived from biomass is used. In addition to a function as a fuel property detection apparatus that detects a concentration of the fuel component (according to the present embodiment, a concentration of ethanol) in the fuel, the apparatus of the present embodiment also has a function as an abnormality detection apparatus that detects an abnormality of the fuel property detection apparatus.

As shown in FIG. 1, the apparatus of the present embodiment includes a pair of electrodes 10 and 12, a temperature sensor 14 as fuel temperature detecting means, and an ECU (Electronic Control Unit) 50. The electrodes 10 and 12 and the temperature sensor 14 are electrically connected to the ECU 50, respectively. Actuators for engine control such as a fuel injector, a spark plug, and a throttle valve as well as sensors for engine control such as a crank angle sensor and an air/fuel ratio sensor that are provided in an internal combustion engine (hereunder, referred to as “engine”) 70 are electrically connected to the ECU 50.

The electrodes 10 and 12 are arranged inside a fuel passage 60 for feeding a fuel to a fuel injector of the engine 70 from an unshown fuel tank. The electrodes 10 and 12 are both formed in a cylindrical shape, and are concentrically arranged in a state in which the electrode 12 that has a small diameter is inserted inside the electrode 10 that has a large diameter. The electrodes 10 and 12 are arranged so that a central line thereof is parallel to direction of the fuel flow in the fuel passage 60. It is thereby possible to facilitate the flow of fuel into a gap between the electrode 10 and the electrode 12. However, the shape and arrangement of the electrodes according to the present invention is not limited to the configuration illustrated in the drawings, and any kind of shape and arrangement can be adopted as long as a function as a capacitor can be obtained.

The temperature sensor 14 that is composed by, for example, a thermistor is arranged in the vicinity of the electrodes 10 and 12. The temperature of a fuel that is present between the electrodes 10 and 12 can be detected by the temperature sensor 14.

The ECU 50 has a function that measures a capacitance between the electrodes 10 and 12. The capacitance between the electrodes 10 and 12 (hereunder, referred to simply as “capacitance”) changes in accordance with the permittivity of a fuel that is present between the electrodes 10 and 12. The relative permittivity of ethanol is approximately 24, and the relative permittivity of gasoline is approximately 2. Therefore, the permittivity of an ethanol-gasoline blended fuel changes according to a concentration of ethanol contained in the fuel (hereunder, referred to simply as “ethanol concentration”). Accordingly, the capacitance changes according to the ethanol concentration of the ethanol-gasoline blended fuel that is present between the electrodes 10 and 12.

The permittivity of a substance changes in accordance with the temperature. Therefore, the capacitance also changes in accordance with the temperature. Accordingly, the capacitance changes according to the ethanol concentration and the temperature of the fuel that is present between the electrodes 10 and 12. FIG. 2 is a view that illustrates the relationship between the ethanol concentration and the temperature of a fuel and the capacitance. A map (hereunder, referred to as “ethanol concentration calculation map”) such as the map shown in FIG. 2 is previously stored in the ECU 50. The ECU 50 can calculate an ethanol concentration of a fuel that is inside the fuel passage 60 by applying a measured capacitance and a fuel temperature that is detected by the temperature sensor 14 to the ethanol concentration calculation map shown in FIG. 2.

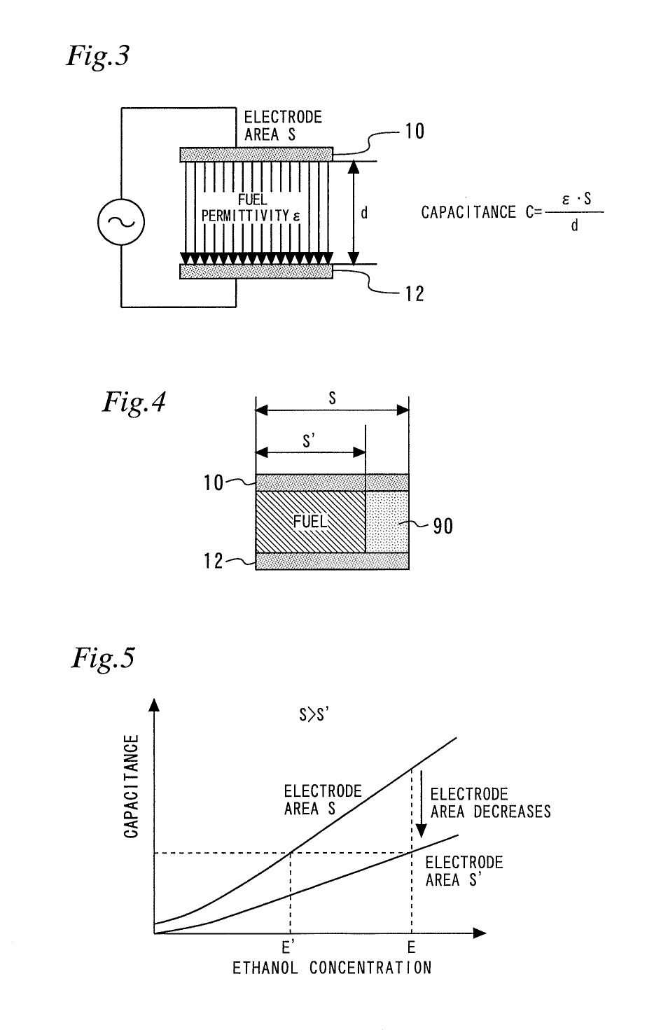

FIG. 3 is a view that schematically illustrates the electrodes 10 and 12. The ECU 50 applies an alternating voltage between the electrodes 10 and 12, and measures the capacitance. In FIG. 3, when reference character S represents an electrode area, reference character d represents an electrode interval, reference symbols represents a permittivity of a fuel, and reference character C represents a capacitance, the following equation holds:

C=ε*S/d (1)

When a fuel that includes a gum component is continuously used, the gum component may gradually adhere and accumulate in the gap between the electrodes 10 and 12. FIG. 4 is a view that schematically illustrates a state in which one portion of the gap between the electrodes 10 and 12 is blocked by a deposit 90 of the gum component. As shown in FIG. 4, although an effective electrode area that sandwiches a fuel is an area denoted by reference character S in a normal state, the effective electrode area decreases to the area denoted by reference character S′ in a state in which the deposit 90 of the gum component has arisen.

FIG. 5 is a view that compares a capacitance in a normal state in which there is no deposit in the gap between the electrodes 10 and 12 and a capacitance in a state in which the deposit 90 exists as shown in FIG. 4. As shown in FIG. 5, in a state in which the deposit 90 exists in the gap between the electrodes 10 and 12, the capacitance decreases compared to the normal case. The reason is as follows. The permittivity of a gum component is significantly smaller than the permittivity of ethanol. Consequently, the capacitance in an electrode region that is blocked by the deposit 90 is less than in an electrode region in which a fuel containing ethanol is present between the electrodes. As will be understood from the above equation (1), the capacitance is proportional to the electrode area. Since the effective electrode area decreases to the area denoted by S′ when the deposit 90 is present, the capacitance also decreases by a corresponding amount. Thus, the capacitance of the electrode region that is blocked by the deposit 90 is less than in a case where a fuel containing ethanol is present between the electrodes. Therefore, the overall capacitance is also less than in a normal state. Consequently, in comparison to the normal state, a capacitance measurement value is lower in a state in which the deposit 90 is present between the electrodes 10 and 12. As a result, in FIG. 5, although the actual ethanol concentration is E, the ethanol concentration is erroneously detected as a concentration E′ that is lower than the concentration E. Accordingly, when the deposit 90 arises between the electrodes 10 and 12, it is desirable that the deposit 90 can be detected as an abnormality of the fuel property detection apparatus.

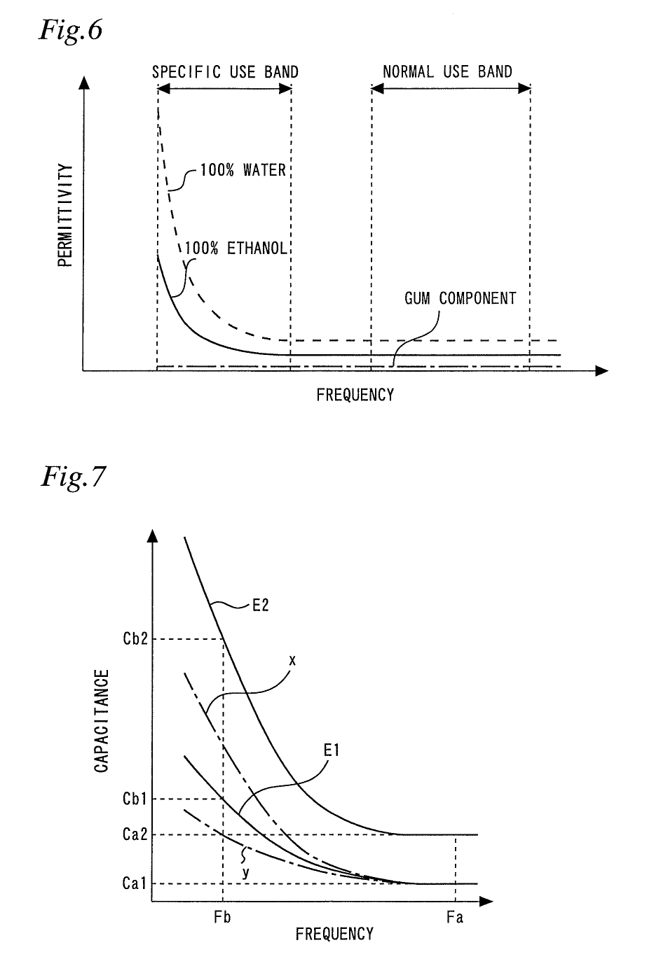

In this connection, it is known that the permittivity of a dielectric changes according to a frequency of an electric field (dielectric relaxation). The frequency characteristics of the permittivity of a substance are decided for each substance. FIG. 6 is a view that illustrates the relationship between the permittivity and frequency with respect to (1) 100% water, (2) 100% ethanol, and (3) a gum component. As shown in FIG. 6, although the permittivity of water or ethanol is constant in a high frequency band (normal use band), in a low frequency band (specific use band) the permittivity increases as the frequency decreases. Accordingly, when a fuel contains ethanol, if a frequency of an alternating voltage that is applied between the electrodes 10 and 12 (hereunder, referred to as “electrode application voltage”) is in a low frequency band, since the permittivity of ethanol increases compared to a case where the frequency is in a high frequency band, the measured capacitance value also increases.

In contrast, as shown in FIG. 6, the permittivity of a gum component is constant and does not depend on the frequency. Further, the permittivity of gasoline is approximately constant and does not depend on the frequency. Accordingly, the permittivity of a gum component or gasoline is approximately the same in a case where the electrode application voltage is in a low frequency band and a case where the electrode application voltage is in a high frequency band.

FIG. 7 is a view that illustrates the relationship between the frequency of an electrode application voltage (hereunder, may also be referred to simply as “frequency”) and the capacitance. In FIG. 7, a solid-line graph denoted by E1 represents a case in which the fuel property detection apparatus is operating normally and the ethanol concentration is E1, and a solid-line graph denoted by E2 represents a case in which the fuel property detection apparatus is operating normally and the ethanol concentration is E2 (where, E2>E1>0). As shown in FIG. 7, in a low frequency band, the permittivity of ethanol rises, and consequently the capacitance increases. Furthermore, the higher that the ethanol concentration of a fuel is, the greater the degree to which the capacitance increases in a low frequency band. When the fuel temperature is made constant, this frequency characteristic of the capacitance is an inherent characteristic that depends on the ethanol concentration. According to the present embodiment, the existence or non-existence of an abnormality of the fuel property detection apparatus can be accurately determined utilizing this fact.

A first frequency Fa in FIG. 7 is a frequency that is normally used for detecting the ethanol concentration of a fuel. The first frequency Fa is a predetermined frequency that belongs to a range of the normal use band shown in FIG. 6. More specifically, the first frequency Fa belongs to a high frequency band in which the permittivity of ethanol is constant and does not depend on the frequency. Hereunder, a capacitance at the first frequency Fa is represented by “Ca”.

In contrast, a second frequency Fb in FIG. 7 is a predetermined frequency that belongs to a range of the specific use band shown in FIG. 6. More specifically, the second frequency Fb belongs to a low frequency band in which the permittivity of ethanol increases more than in the normal use band. When detecting an abnormality of the fuel property detection apparatus, an alternating voltage of the second frequency Fb is applied between the electrodes 10 and 12 and the capacitance is measured. Hereunder, the capacitance at the second frequency Fb is represented by “Cb”.

In FIG. 7, graphs formed by alternate long and short dashed lines denoted by x and y illustrate examples of frequency characteristics of the capacitance in a case where a deposit of a gum component exists between the electrodes 10 and 12, a case where rust (corrosion) has developed on the electrodes 10 and 12, a case where there is an abnormality in a circuit of the fuel property detection apparatus, or a case where there is an error in a detection value of the temperature sensor 14 or the like (hereunder, this cases are referred to collectively as “characteristic abnormality”). The graphs x and y are equal to the graph E1 with respect to the capacitance Ca at the first frequency Fa. Consequently, by measuring only the capacitance Ca at the first frequency Fa it is not possible to distinguish between the graphs x and y for a case where there is a characteristic abnormality in the fuel property detection apparatus and the graph E1 for a case where the fuel property detection apparatus is operating normally. However, if there is a characteristic abnormality in the fuel property detection apparatus, the frequency characteristics of the capacitance are different from the frequency characteristics during normal operation. More specifically, even if the capacitance Ca at the first frequency Fa by chance matches the graph E1, a divergence with the graph E1 increases as the frequency decreases, and the capacitance Ca will shift to the upper side as shown by the graph x or shift to the lower side as shown by the graph y. Accordingly, it is possible to accurately distinguish between the normal case as shown by the graph E1 and the case of a characteristic abnormality as shown by the graph x or y by measuring a capacitance Cb at the second frequency Fb in addition to the capacitance Ca at the first frequency Fa.

As shown in FIG. 7, a ratio between the capacitance Ca at the first frequency Fa and the capacitance Cb at the second frequency Fb is Cb1/Ca1 at the ethanol concentration E1 and is Cb2/Ca2 at the ethanol concentration E2. However, these two values are different from each other (Cb1/Ca1≠Cb2/Ca2). More specifically, the ratio between the capacitance Ca at the first frequency Fa and the capacitance Cb at the second frequency Fb is a value that differs according to the ethanol concentration. Thus, in a case where the fuel property detection apparatus is operating normally, when the fuel temperature is made constant, a ratio between a capacitance at a low frequency band (specific use band) and the capacitance Ca at the first frequency Fa has an inherent frequency characteristic that depends on the ethanol concentration.

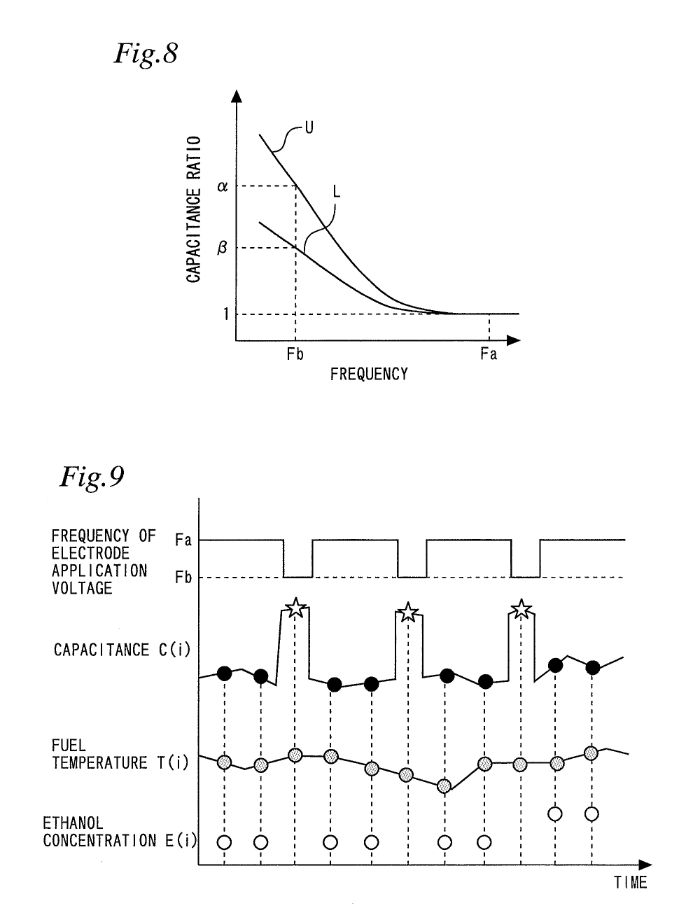

FIG. 8 is a view for describing an abnormality detection method according to the present embodiment. The horizontal axis in FIG. 8 represents frequency and the vertical axis represents values (hereunder, referred to as “capacitance ratio”) obtained by dividing a capacitance at each frequency by the capacitance at the first frequency Fa. As described above, when the fuel temperature is made constant, the capacitance ratio has an inherent frequency characteristic that depends on the ethanol concentration. In FIG. 8, curves denoted by reference characters U and L represent upper limit values and lower limit values of capacitance ratios that are recognized as the range of a normal error. Further, reference character a denotes an upper limit value of a normal range of the capacitance ratio at the second frequency Fb, and reference character β denotes a lower limit value of the normal range of the capacitance ratio at the second frequency Fb. Since the frequency characteristic of the capacitance ratio changes in accordance with the ethanol concentration and the fuel temperature, the upper limit value α and the lower limit value β also change in accordance with the ethanol concentration and the fuel temperature. A two-dimensional map for calculating the upper limit value α and the lower limit value β of the normal range of the capacitance ratio at the second frequency Fb (hereunder, referred to simply as “capacitance ratio”) based on the ethanol concentration and fuel temperature is previously stored in the ECU 50. The ECU 50 determines the upper limit value α and the lower limit value β based on the aforementioned map (hereunder, referred to as “normal ratio map”) and the current ethanol concentration and fuel temperature. The ECU 50 also calculates the capacitance ratio Cb/Ca based on the capacitance Ca that is measured at the first frequency Fa and the capacitance Cb that is measured at the second frequency Fb. If the calculated value is between the upper limit value α and the lower limit value β, the ECU 50 determines that the fuel property detection apparatus is normal, and if the calculated value is outside the upper limit value α and the lower limit value β the ECU 50 determines that there is an abnormality in the fuel property detection apparatus.

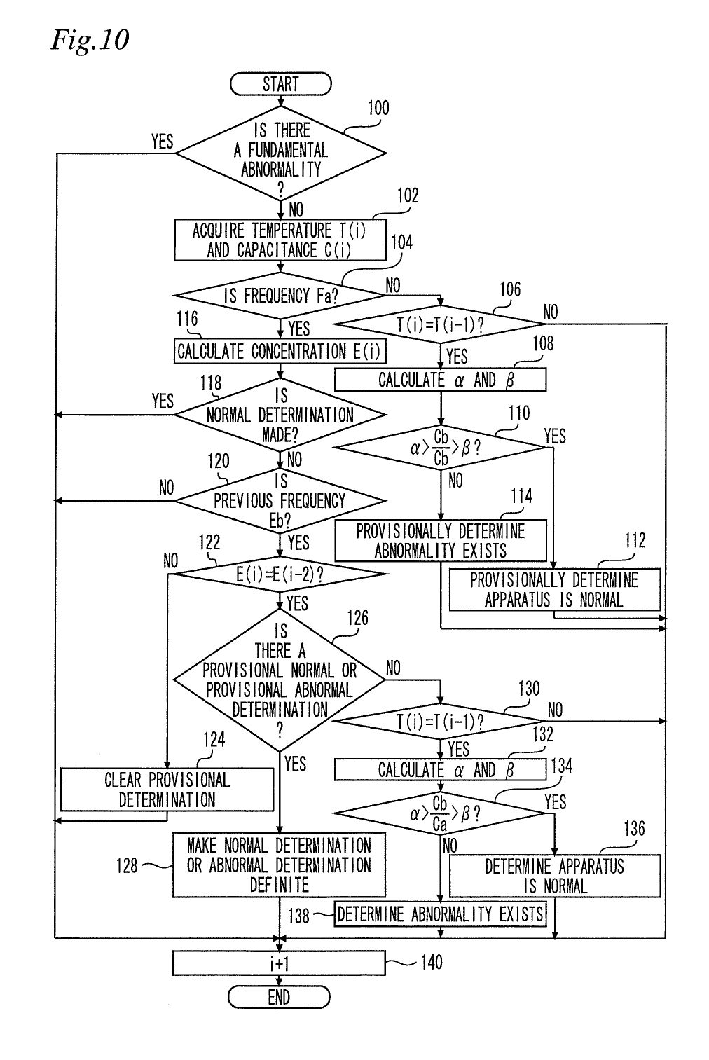

According to the present embodiment, the frequency of the electrode application voltage is switched between the first frequency Fa and the second frequency Fb at fixed time intervals. FIG. 9 is a view that illustrates an example of changes over time in the frequency of the electrode application voltage as well as detection values for the capacitance, fuel temperature and ethanol concentration. The capacitance is measured at predetermined sampling intervals. According to the present embodiment, as shown in FIG. 9, time intervals for switching the frequency are set so that, among three samplings, the capacitance at the second frequency Fb (denoted by a star sign in the figure) is measured once and the capacitance at the first frequency Fa (denoted by a black circle in the figure) is measured twice. Note that according to the example shown in FIG. 9, the fuel temperature and ethanol concentration are also detected at the same sampling intervals as the capacitance.

The abnormality detection method of the present embodiment is based on a premise that the ethanol concentration and temperature of a fuel that is present between the electrodes 10 and 12 does not change between a time of measuring the capacitance Ca at the first frequency Fa (hereunder, referred to as “first capacitance”) and a time of measuring the capacitance Cb at the second frequency Fb (hereunder, referred to as “second capacitance”). Therefore, according to the present embodiment, it is determined whether there is a change in the ethanol concentration and the fuel temperature between the time of measuring the first capacitance Ca and the time of measuring the second capacitance Cb, and if it is found that even one of the ethanol concentration and the fuel temperature changes, a result determined by the abnormality detection method is taken as invalid.

FIG. 10 is a flowchart of a routine that the ECU 50 executes according to the present embodiment in order to diagnose an abnormality of the fuel property detection apparatus based on the above described principles. The present routine is repeatedly executed at predetermined time periods. Hereunder, the number of times the routine is executed is represented by “i”.

According to the routine shown in FIG. 10, first, the ECU 50 checks for the existence or non-existence of a fundamental abnormality (step 100). A fundamental abnormality that the ECU 50 checks for in step 100 is an abnormality that is due to a fundamental cause such as, for example, a disconnected circuit, that can be diagnosed by a conventional abnormality diagnosis operation. The ECU 50 determines the existence or non-existence of a fundamental abnormality by means of a separate routine. In contrast, the abnormality diagnosis according to the present routine can precisely detect a characteristic abnormality that occurs due to a cause such as a deposit of a gum component being present between the electrodes 10 and 12 or rust (corrosion) at the electrodes 10 and 12, or a cause such as an abnormality in a circuit of the fuel property detection apparatus or an error in a detection value of the temperature sensor 14. If there is a fundamental abnormality, since the fuel property detection apparatus clearly recognizes the abnormality, it is not necessary to execute the present routine. Therefore, in the aforementioned step 100, when it is recognized that there is a fundamental abnormality, the processing is ended at this point.

In contrast, if it is determined that there is no fundamental abnormality in the aforementioned step 100, a fuel temperature (i) detected by the temperature sensor 14 and a measurement value C(i) of the capacitance (step 102) are acquired. Next, the ECU 50 determines whether or not the current electrode application frequency is the first frequency Fa (step 104).

In the aforementioned step 104, if the current frequency is not the first frequency Fa, it means that the current frequency is the second frequency Fb. Accordingly, the capacitance measurement value C(i) acquired in the above step 102 corresponds to the second capacitance Cb. Further, when the current frequency is the second frequency Fb, based on the relationship shown in FIG. 9, it means that the previous frequency was the first frequency Fa. Accordingly, the previous capacitance measurement value C(i−1) corresponds to the first capacitance Ca. Hence, in this case, the capacitance ratio Cb/Ca can be calculated by dividing the current capacitance measurement value C(i) by the previous capacitance measurement value C(i−1), and thus the preparation for performing an abnormality diagnosis is completed. Therefore, in this case, the ECU 50 next determines whether or not the current fuel temperature T(i) and the previous fuel temperature (i−1) are the same (step 106). As described in the foregoing, the present embodiment is based on the premise that there is no change in the fuel temperature between the time of measuring the first capacitance Ca and the time of measuring the second capacitance Cb. Therefore, in the aforementioned step 106, if the current fuel temperature T(i) and the previous fuel temperature (i−1) do not match, diagnosis is not performed and the processing ends at this point.

In contrast, in the aforementioned step 106, if the current fuel temperature T(i) and the previous fuel temperature (i−1) are the same, in order to perform diagnosis, first, the upper limit value α and the lower limit value β of a normal range of the capacitance ratio are calculated (step 108). As described above, the upper limit value α and the lower limit value β are calculated by applying the present ethanol concentration (ethanol concentration that is detected the previous time) and the present fuel temperature T(i) to the normal ratio map. Subsequently, the ECU 50 calculates the capacitance ratio Cb/Ca by dividing the current capacitance measurement value C(i) by the previous capacitance measurement value C(i−1), and determines whether or not the calculated capacitance ratio Cb/Ca is between the upper limit value α and the lower limit value β (step 110). If the capacitance ratio Cb/Ca is between the upper limit value α and the lower limit value β, the ECU 50 provisionally determines that the fuel property detection apparatus is normal (step 112). If the capacitance ratio Cb/Ca is not between the upper limit value α and the lower limit value β, the ECU 50 provisionally determines that there is an abnormality in the fuel property detection apparatus (step 114). As described above, the present embodiment is based on the premise that there is no change in the ethanol concentration between the time of measuring the first capacitance Ca and the time of measuring the second capacitance Cb. The reason the ECU 50 makes a provisional determination in the above described step 112 or 114 is that at this stage it has not been confirmed that there is no change in the ethanol concentration.

The description will now return to a case in which the ECU 50 determines in the aforementioned step 104 that the current frequency is the first frequency Fa. In this case, the current capacitance measurement value C(i) corresponds to the first capacitance Ca. In this case, next, the ECU 50 calculates an ethanol concentration E(i) by applying the fuel temperature T(i) and the capacitance C(i) acquired in the above step 102 to the ethanol concentration calculation map shown in FIG. 2 (step 116). The calculated ethanol concentration E(i) is the ethanol concentration of the fuel that is currently between the electrodes 10 and 12. Subsequently, the ECU 50 determines whether or not a normal determination has already been output by the processing of the present routine (step 118). If a normal determination has already been output, since it is not necessary to execute the subsequent processing, the processing is ended at this point. In contrast, if a normal determination has not yet been output, next the ECU 50 determines whether or not the previous frequency was the second frequency Fb (step 120). If the previous frequency was not the second frequency Fb, the processing is ended at this point.

If it is determined in the above step 120 that the previous frequency was the second frequency Fb, the previous capacitance measurement value C(i−1) is applied to the second capacitance Cb. In this case, with respect to the time before last, the frequency was the first frequency Fa and the ethanol concentration has been detected. Next, the ECU 50 determines whether or not the ethanol concentration E(i) that is detected the current time and an ethanol concentration E(i−2) that was detected the time before last are the same (step 122). If the current ethanol concentration E(i) and the ethanol concentration E(i−2) that was detected the time before last do not match, the premise for the diagnosis does not hold true. Hence, in this case, if a provisional determination has been made in the aforementioned step 112 or 114, the provisional determination is cancelled (step 124), and the processing of the present routine is ended at this point.

In contrast, if it is determined in the above step 122 that the current ethanol concentration E(i) and the ethanol concentration E(i−2) that was detected the time before last are the same, diagnosis can be performed. In this case, first, the ECU 50 determines whether or not a provisional determination has been made in the above step 112 or 114 (step 126). If a provisional determination has already been made, the provisional determination is confirmed and taken as the actual determination (step 128). On the other hand, if a provisional determination has not been made, the ECU 50 determines the existence or non-existence of an abnormality in the same manner as described above. More specifically, first, the ECU 50 determines whether or not the current fuel temperature T(i) and the previous fuel temperature (i−1) are the same (step 130). If the current fuel temperature T(i) and the previous fuel temperature (i−1) do not match, the diagnosis is not performed and the processing is ended at this point. If the current fuel temperature T(i) and the previous fuel temperature (i−1) are the same, in order to perform diagnosis, the upper limit value α and the lower limit value β of a normal range of the capacitance ratio are calculated by applying the present ethanol concentration E(i) and the present fuel temperature T(i) to the normal ratio map (step 132). Next, the capacitance ratio Cb/Ca is calculated by dividing the previous capacitance measurement value C(i−1) by the current capacitance measurement value C(i), and it is determined whether or not the calculated capacitance ratio Cb/Ca is between the upper limit value α and the lower limit value β (step 134). If the capacitance ratio Cb/Ca is between the upper limit value α and the lower limit value β, the ECU 50 determines (actual determination) that the fuel property detection apparatus is normal (step 136). If the capacitance ratio Cb/Ca is not between the upper limit value α and the lower limit value β, the ECU 50 determines (actual determination) that there is an abnormality in the fuel property detection apparatus (step 138).

After the processing of the present routine has been terminated as the result of any of the above described operations, the number of executions i is incremented by 1 (step 140). Note that although the present embodiment adopts a configuration, as shown in FIG. 9, that switches the frequency to the second frequency Fb once out of every three times, since it is not necessary to switch to the second frequency Fb after the actual determination has been output, a configuration may be adopted that stops switching the frequencies and fixes the frequency to the first frequency Fa after the actual determination has been output. When the frequency is fixed to the first frequency Fa, there is the advantage that the ethanol concentration can be detected each time.

According to the present embodiment as described above, a diagnosis of the fuel property detection apparatus can be conducted by comparing information relating to an inherent frequency characteristic of a capacitance that is in accordance with a fuel property (ethanol concentration), with a measurement value of the capacitance. It is thereby possible to conduct an accurate diagnosis even when there is an abnormality (for example, a build-up of a gum component at electrodes or rusting of the electrodes) in a case in which the characteristics of the fuel property detection apparatus slowly change.

In this connection, although the present embodiment has been described by taking a fuel property detection apparatus that detects an ethanol concentration of an ethanol-gasoline blended fuel as an example, a fuel property detection apparatus that is an object of the present invention is not limited to an apparatus that detects a property of an ethanol-containing fuel. The present invention can be broadly and generally applied to apparatuses that detect a property of a fuel that includes a fuel component that has a characteristic such that a permittivity thereof changes in accordance with a frequency, such as, for example, an apparatus that detects a property of a fuel containing ETBE (ethyl tertiary butyl ether) or a fuel containing fatty acid methyl ester.

Furthermore, although according to the present embodiment an abnormality diagnosis is conducted based on capacitances that are measured at two points, namely, the first frequency Fa and the second frequency Fb, according to the present invention a configuration may be adopted so as to conduct an abnormality diagnosis after measuring capacitances at three or more points.

In the above described Embodiment 1, the ECU 50 corresponds to the “frequency switching means”, the “measuring means”, and the “storing means” according to the first invention, respectively, and the normal ratio map corresponds to the “frequency characteristics information” according to the first invention. Further, the “diagnosing means” according to the first invention is realized by the ECU 50 executing the processing of the routine shown in FIG. 10, the “normal ratio acquiring means” according to the second and third invention is realized by the ECU 50 executing the processing of the above described steps 108 and 132, and the “abnormality determining means” according to the second and third invention is realized by the ECU 50 executing the processing of the above described steps 110, 112, 114, 134, 136, and 138.

### Embodiment 2

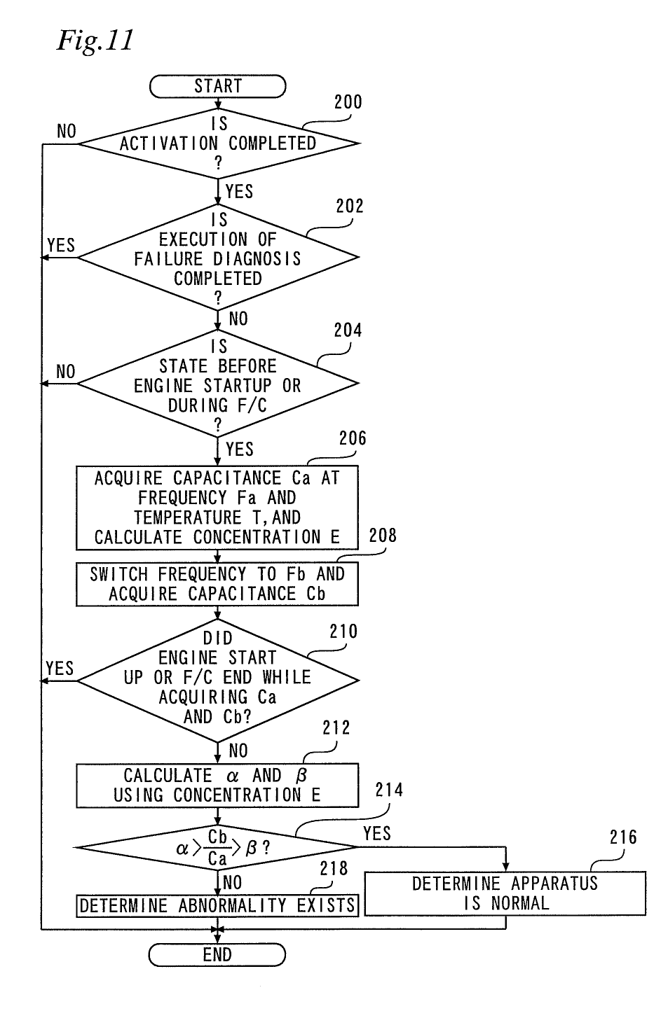

Next, Embodiment 2 of the present invention is described referring to FIG. 11. The description of Embodiment 2 centers on differences with respect to the foregoing Embodiment 1, and a description of like items is simplified or omitted. The hardware configuration of the present embodiment is the same as in Embodiment 1.

According to the foregoing Embodiment 1, normally the capacitance is measured by periodically switching the frequency between the first frequency Fa and the second frequency Fb. Subsequently, when it is confirmed that there is no change in the ethanol concentration and the fuel temperature, which is a prerequisite for conducting a failure diagnosis, the diagnosis is conducted.

In contrast, according to the present embodiment, the frequency is switched to the second frequency Fb and the capacitance and diagnosis is conducted in a state in which it is certain that there is no change in an ethanol concentration and a fuel temperature. It is thereby possible to avoid switching the frequency unnecessarily to the second frequency Fb.

As examples of a state in which it is certain that there is no change in an ethanol concentration and a fuel temperature, a state before starting the engine 70 or a state during execution of a fuel cut operation in which fuel injection from the fuel injector of the engine 70 is temporarily stopped may be mentioned. Before starting the engine 70 or during execution of a fuel cut operation, since fuel is in a retained state and is not flowing inside the fuel passage 60, even if the state is a state that is immediately after fuel with a different ethanol concentration has been fed into the fuel tank, the ethanol concentration of the fuel that is between the electrodes 10 and 12 does not change. Further, since a diagnosis is completed in a short time, it is possible to also ignore a change in the fuel temperature between the electrodes 10 and 12 that is caused by external heat that is received by the fuel during that time period. Therefore, according to the present embodiment, a configuration is adopted that switches the frequency to the second frequency Fb before starting the engine 70 or during execution of a fuel cut operation and performs a diagnosis.

FIG. 11 is a flowchart of a routine that the ECU 50 executes according to the present embodiment in order to realize the above described function. According to the routine shown in FIG. 11, first, the ECU 50 determines whether or not the fuel property detection apparatus is activated (step 200). If activation of the fuel property detection apparatus is completed, the ECU 50 determines whether or not a failure diagnosis has been completed (step 202). If the fuel property detection apparatus has not yet been activated or if a failure diagnosis has already been completed, the ECU 50 ends the processing at that point.

In contrast, if the ECU 50 determines in the aforementioned step 202 that a failure diagnosis has not yet been completed, next the ECU 50 determines whether or not the current state corresponds to a state before startup of the engine 70 or during execution of a fuel cut operation (step 204). The term “before startup of the engine” as used herein refers to a state in which a request to start the engine has been received but starting has not yet been performed, a state in which the engine 70 is being subjected to a cranking operation by a starter motor, or a state in which, in a hybrid vehicle that uses the engine 70 and an electric motor as a source of power, the engine 70 is stopped and the vehicle is running by means of only the motive power of the electric motor. Further, the term “fuel cut operation” includes a deceleration fuel cut operation that stops the fuel supply to the engine 70 at a time of deceleration of the engine 70 when the number of revolutions of the engine is higher than a predetermined number of revolutions, and a high-speed fuel cut operation that stops the fuel supply to the engine 70 when the vehicle speed exceeds a predetermined speed limit. In the aforementioned step 204, if the ECU 50 determines that the state is not a state before startup of the engine 70 and is also not a state during execution of a fuel cut operation, the ECU 50 ends the processing at this point.

In contrast, in the aforementioned step 204, if the ECU 50 determines that the state corresponds to a state before startup of the engine 70 or a state during execution of a fuel cut operation, the diagnosis can be performed. In this case, first, the ECU 50 acquires a fuel temperature T that is detected by the temperature sensor 14 and a measurement value of the capacitance at the first frequency Fa (that is, the first capacitance Ca), and calculates the ethanol concentration E by applying those values to the ethanol concentration calculation map shown in FIG. 2 (step 206). Next, the frequency is switched to the second frequency Fb and the capacitance (that is, the second capacitance Cb) is measured (step 208). Subsequently, the ECU 50 determines whether or not the engine 70 has been started up or the fuel cut operation has ended during the period from the time of acquiring the first capacitance Ca (step 206) until the time of acquiring the second capacitance Cb (step 208) (step 210). If the engine 70 has been started up or the fuel cut operation has ended, there is a possibility that the ethanol concentration or the fuel temperature has changed, and hence the ECU 50 ends the processing at this point without conducting a diagnosis.

In contrast, if the ECU 50 determines in the aforementioned step 210 that the engine 70 has not been started up and the fuel cut operation has not ended, the diagnosis can be conducted. In this case, first, the ECU 50 calculates the upper limit value α and the lower limit value β of the normal range of the capacitance ratio by applying the present ethanol concentration E and the present fuel temperature T to the normal ratio map (step 212). Next, the capacitance ratio Cb/Ca is calculated, and the ECU 50 determines whether or not the calculated capacitance ratio Cb/Ca is between the upper limit value α and the lower limit value β (step 214). If the capacitance ratio Cb/Ca is between the upper limit value α and the lower limit value β, the ECU 50 determines that the fuel property detection apparatus is normal (step 216). If the capacitance ratio Cb/Ca is not between the upper limit value α and the lower limit value β, the ECU 50 determines that there is an abnormality in the fuel property detection apparatus (step 218).

According to the above described Embodiment 2, in addition to obtaining the same advantages as in the foregoing Embodiment 1, the number of times that the frequency is switched to the second frequency Fb can be kept to the necessary minimum. In Embodiment 2 as described above, the “frequency switching means” and “diagnosing means” of the fifth invention are respectively realized by the ECU 50 executing the processing of the routine shown in FIG. 11.

### Embodiment 3

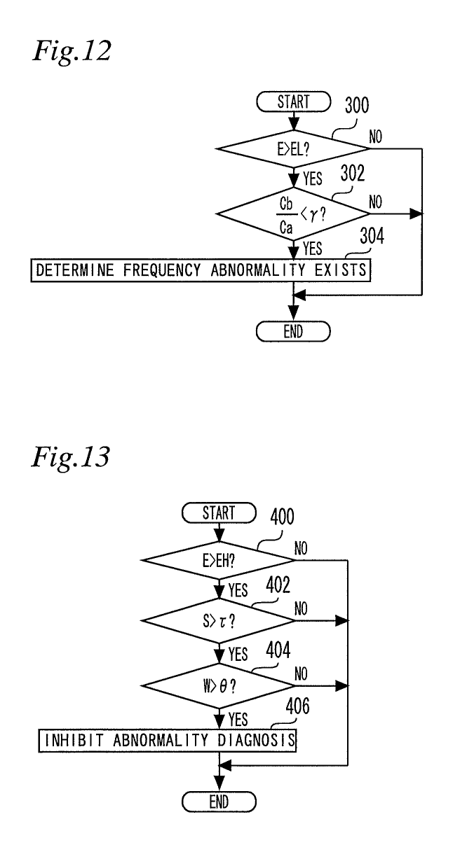

Next, Embodiment 3 of the present invention is described referring to FIG. 12. The description of Embodiment 3 centers on differences with respect to the above described embodiments, and a description of like items is simplified or omitted. The hardware configuration of the present embodiment is the same as in Embodiment 1. The present embodiment is implemented in combination with the aforementioned Embodiment 1 or 2.

According to the present embodiment, when diagnosing an abnormality of a fuel property detection apparatus, it is determined whether or not the electrode application frequency has been correctly switched from the first frequency Fa to the second frequency Fb. In a case where, due to some cause, the frequency has not been correctly switched from the first frequency Fa to the second frequency Fb, an operation to diagnose an abnormality is inhibited because it is not possible to correctly diagnose an abnormality of the fuel property detection apparatus.

If the actual frequency is not correctly switched to the second frequency Fb, and the second capacitance Cb is measured while the actual frequency remains at the first frequency Fa, there will be almost no difference between a value that is measured as the second capacitance Cb and the first capacitance Ca, and the two capacitances will be approximately the same value. Therefore, the capacitance ratio Cb/Ca will be 1 or a value close to 1. Thus, according to the present embodiment, when the capacitance ratio Cb/Ca is less than a predetermined determination value γ, it is determined that an abnormality exists with respect to the frequency switching operation. The determination value γ is a predetermined value that is greater than 1 and less than the lower limit value β of the normal range of the capacitance ratio. That is, β>γ>1.

However, since the permittivity of gasoline is approximately constant and does not depend on the frequency, when the fuel is 100% gasoline or when the fuel has a low ethanol concentration, even if the frequency has been correctly switched to the second frequency Fb, the second capacitance Cb will be approximately the same value as the first capacitance Ca. Thus, Cb/Ca≈1. In such a case, even if Cb/Ca<γ, it should not be determined that an abnormality exists with respect to a frequency switching operation. Therefore, when the ethanol concentration is less than or equal to a predetermined threshold value, a diagnosis of an abnormality with respect to a frequency switching operation is not performed.

FIG. 12 is a flowchart of a routine that the ECU 50 executes to diagnose an abnormality with regard to a frequency switching operation. In the present embodiment, the routine shown in FIG. 12 is executed in conjunction with the routine of FIG. 10 or FIG. 11 as described above. According to the routine shown in FIG. 12, first, the ECU 50 determines whether or not the ethanol concentration E is greater than a predetermined threshold value EL (step 300). The threshold value EL is a value that is previously set in order to exclude a case in which the fuel is 100% gasoline or the ethanol concentration is low. If the ethanol concentration E is less than or equal to the threshold value EL, the ECU 50 ends the processing at this point without performing an abnormality diagnosis with respect to the frequency switching operation. In contrast, if the ethanol concentration E is higher than the threshold value EL, the ECU 50 determines whether or not the capacitance ratio Cb/Ca is less than γ (step 302). If the result determined by ECU 50 is that Cb/Ca<γ, the ECU 50 determines that there is an abnormality in the frequency switching operation (step 304). When it is determined that there is an abnormality in the frequency switching operation, since it is not possible to accurately diagnose an abnormality of the fuel property detection apparatus, execution of the abnormality diagnosis is inhibited.

In the above described Embodiment 3, the “second diagnosing means” according to the sixth and the seventh invention is realized by the ECU 50 executing the processing of the routine shown in FIG. 12.

### Embodiment 4

Next, Embodiment 4 of the present invention is described referring to FIG. 13. The description of Embodiment 4 centers on differences with respect to the above described embodiments, and a description of like items is simplified or omitted. The hardware configuration of the present embodiment is the same as in Embodiment 1. The present embodiment is implemented in combination with any one of the foregoing Embodiments 1 to 3.

It is known that when water is added to an ethanol-gasoline blended fuel and the fuel is left to stand, the fuel separates into a phase of an ethanol component and a phase of a gasoline component. Therefore, in the fuel supply channel of the engine 70 also, when a water content of a fuel is high, an ethanol concentration of the fuel is high, and an engine stoppage period is long, there is a possibility that the fuel will undergo a phase separation into ethanol and gasoline. When a phase separation occurs, a change also appears in a capacitance measurement value due to the influence of the phase separation. Hence, when performing a diagnosis of a fuel property detection apparatus, there is a risk that an abnormality will be erroneously determined irrespective of the fact that the apparatus is normal. Therefore, according to the present embodiment, a configuration is adopted that inhibits execution of an abnormality diagnosis when there is a possibility that the fuel has undergone a phase separation.

FIG. 13 is a flowchart of a routine that the ECU 50 executes in order to realize the above described function. According to the present embodiment, the routine shown in FIG. 13 is executed in conjunction with the above described routine of FIG. 10 or FIG. 11. According to the routine shown in FIG. 13, first, the ECU 50 determines whether or not the ethanol concentration E is greater than a predetermined threshold value EH (step 400). If the ethanol concentration E is less than or equal to the threshold value EH, it can be determined that there is no possibility that a phase separation has occurred, and hence the processing ends at this point. In contrast, if the ethanol concentration E is higher than the threshold value EH, next, the ECU 50 determines whether or not a stoppage period S from a time at which the engine 70 was last stopped until the current start up operation is longer than a predetermined threshold value τ (step 402). The threshold value τ is set, for example, as a period of approximately several days to several weeks. If the engine stoppage period S is equal to or less than the threshold value τ, since it can be determined that there is no possibility that a phase separation has occurred, the ECU 50 ends the processing at this point. In contrast, if the engine stoppage period S is longer than the threshold value τ, next the ECU 50 determines whether or not a water content W of the fuel is higher than a predetermined threshold value θ (step 404). The water content W is detected by a water content sensor (not shown), or may be estimated by a known method (for example, a method disclosed in Japanese Patent Laid-Open No. 2009-145131). If the water content W is less than or equal to the threshold value θ, it can be determined that there is no possibility that a phase separation has occurred, and hence the processing is ended at this point.

In contrast, if the ethanol concentration E is higher than the threshold value EH, the engine stoppage period S is longer than the threshold value τ, and the water content W is higher than the threshold value θ, it can be determined that there is a possibility that the fuel has undergone a phase separation. In this case, since there is a possibility that an abnormality of the fuel property detection apparatus can not be accurately diagnosed, execution of the abnormality diagnosis is inhibited in order to avoid an erroneous diagnosis (step 406).

In the above described Embodiment 4, “phase separation determining means” according to the eighth and ninth inventions is realized by the ECU 50 executing the processing of the aforementioned steps 400, 402, and 404.

In this connection, according to the present invention, when there is a possibility that a fuel has undergone a phase separation or when the water content of the fuel is high, if means for eliminating the influence of the phase separation or the high water content is provided, a diagnosis of the fuel property detection apparatus may be executed. For example, when there is a possibility that a fuel has undergone a phase separation, by providing a mechanism that eliminates the phase separation by stirring fuel in the vicinity of the electrodes 10 and 12, or by correcting the influence of the water content by a known method (for example, a method disclosed in Japanese Patent Laid-Open No. 2009-145131), it is possible to correctly execute a diagnosis of the fuel property detection apparatus.

### REFERENCE SIGNS LIST

10, 12 electrode

14 temperature sensor

50 ECU

60 fuel passage

70 engine

90 deposit

1-9. (canceled)

10. An abnormality detection apparatus for a fuel property detection apparatus that detects an abnormality of a fuel property detection apparatus that detects a fuel property based on a measurement value of a capacitance between a pair of electrodes that are installed on a fuel supply channel of an internal combustion engine that is capable of using a fuel including a predetermined fuel component that has a characteristic such that a permittivity thereof changes in accordance with a frequency of an electric field, comprising:
frequency switching means that switches a frequency of an alternating voltage that is applied between the two electrodes to a plurality of frequencies at which respective values of a permittivity of the predetermined fuel component are different;
measuring means that measures the capacitance at each of the plurality of frequencies;
storing means that stores frequency characteristics information that is information relating to a relationship between a fuel property and a frequency characteristic of the capacitance in a case where the fuel property detection apparatus is normal; and
diagnosing means that diagnoses an abnormality of the fuel property detection apparatus based on a result of a measurement by the measuring means and the frequency characteristics information.

11. The abnormality detection apparatus for a fuel property detection apparatus according to claim 10, wherein:
the frequency switching means switches a frequency of an alternating voltage that is applied between the two electrodes between a first frequency and a second frequency at which a permittivity of the predetermined fuel component becomes a value that is different from a value thereof at the first frequency;
the measuring means measures a first capacitance that is a capacitance between the two electrodes when an alternating voltage at the first frequency is applied, and a second capacitance that is a capacitance between the two electrodes when an alternating voltage at the second frequency is applied;
the frequency characteristics information is information relating to a relationship between a fuel property and a ratio between the first capacitance and the second capacitance in a case where the fuel property detection apparatus is normal; and
the diagnosing means includes:
normal ratio acquiring means that acquires normal ratio information that is information relating to a normal ratio between the first capacitance and the second capacitance, based on a fuel property that is detected by the fuel property detection apparatus and the frequency characteristics information, and
abnormality determining means that determines an existence or non-existence of an abnormality of the fuel property detection apparatus based on a measurement value of the first capacitance, a measurement value of the second capacitance, and the acquired normal ratio information.

12. The abnormality detection apparatus for a fuel property detection apparatus according to claim 11, wherein:
the normal ratio acquiring means acquires an upper limit value and a lower limit value of a normal ratio between the first capacitance and the second capacitance; and
the abnormality determining means determines that there is an abnormality in the fuel property detection apparatus in a case where a ratio between a measurement value of the first capacitance and a measurement value of the second capacitance is not in a range from the upper limit value to the lower limit value.

13. The abnormality detection apparatus for a fuel property detection apparatus according to claim 11, wherein:
the first frequency is a frequency that the fuel property detection apparatus normally uses to detect a fuel property;
the second frequency is lower than the first frequency; and
a permittivity of the predetermined fuel component at the second frequency is higher than a permittivity of the predetermined fuel component at the first frequency.

14. The abnormality detection apparatus for a fuel property detection apparatus according to claim 10, wherein the frequency switching means switches the frequency to the plurality of frequencies before startup of the internal combustion engine or during execution of a fuel cut operation at the internal combustion engine, and the diagnosing means diagnoses an abnormality of the fuel property detection apparatus based on measurement values of capacitances at the respective frequencies that are measured at that time.

15. The abnormality detection apparatus for a fuel property detection apparatus according to claim 10, further comprising second diagnosing means that diagnoses an abnormality of the frequency switching means based on measurement values of capacitances at each of the plurality of frequencies.

16. The abnormality detection apparatus for a fuel property detection apparatus according to claim 15, wherein the second diagnosing means determines that there is an abnormality in the frequency switching means when a difference between the measurement values of the capacitances at each of the plurality of frequencies is less than a predetermined criterion.

17. The abnormality detection apparatus for a fuel property detection apparatus according to claim 10, further comprising:
phase separation determining means that determines a possibility that a phase separation is occurring among a plurality of components constituting the fuel;
wherein an abnormality diagnosis with respect to the fuel property detection apparatus is not executed when the phase separation determining means determines that there is a possibility that the phase separation is occurring.

18. The abnormality detection apparatus for a fuel property detection apparatus according to claim 17, wherein the phase separation determining means determines a possibility that the phase separation is occurring based on a concentration of the predetermined fuel component, a stoppage period of the internal combustion engine, and information relating to a water content in the fuel.

19. An abnormality detection apparatus for a fuel property detection apparatus that detects an abnormality of a fuel property detection apparatus that detects a fuel property based on a measurement value of a capacitance between a pair of electrodes that are installed on a fuel supply channel of an internal combustion engine that is capable of using a fuel including a predetermined fuel component that has a characteristic such that a permittivity thereof changes in accordance with a frequency of an electric field, comprising:
a frequency switching device that switches a frequency of an alternating voltage that is applied between the two electrodes to a plurality of frequencies at which respective values of a permittivity of the predetermined fuel component are different;
a measuring device that measures the capacitance at each of the plurality of frequencies;
a storing device that stores frequency characteristics information that is information relating to a relationship between a fuel property and a frequency characteristic of the capacitance in a case where the fuel property detection apparatus is normal; and
a diagnosing device that diagnoses an abnormality of the fuel property detection apparatus based on a result of a measurement by the measuring device and the frequency characteristics information.
